(19) United States
(12) Patent Application Publication
(10) Pub. No.: US 2009/0260780 A1
(43) Pub. Date: Oct. 22, 2009

(54) METHOD AND APPARATUS FOR COOLING BREAD JUST AFTER BAKED

(75) Inventors: Yoichi Katori, Suginami-ku (JP); Toru Ota, Sapporo-city (JP); Satoshi Tsutsumi, Saitama-city (JP)

Correspondence Address: ROSSI, KIMMS & McDOWELL LLP., 20609 Gordon Park Square, Suite 150, Ashburn, VA, 20147, US

(73) Assignee: MAYEKAWA MFG., CO., LTD., Koto-ku, Tokyo (JP)

(21) Appl. No.: 12/092,647

(22) PCT Filed: Nov. 4, 2005
(86) PCT No.: PCT/JP2005/020668

§ 371 Date: May 5, 2008

(51) Int. Cl. F28F 5/00; F26B 3/02; F26B 25/08; A23L 1/00

(52) U.S. Cl. 165/86; 34/497; 34/236; 99/467

(57) ABSTRACT

A method and apparatus for cooling bread just after baked are proposed in which bread f just after baked is transferred on a conveyor 2 into a cooling chamber 1 and carried out therefrom after it is allowed to reside therein for a period of time needed for cooling, inside temperature of the cooling chamber is maintained at 5-20° C., hydrated air m is supplied in an upstream side part of the transfer direction of the conveyor where temperature is highest in the cooling chamber 1 to form an atmosphere of high absolute humidity around the transfer passage of the bread f by virtue of the heat of the bread f just after baked, by which the transfer space 3 surrounding the transfer passage of the conveyor 2 is rendered highly humid with relative humidity of 60% or higher, as a result, cooling time is reduced, eating quality is maintained by preventing evaporation of water from the bread while it is cooled just after it is baked, process yield is increased resulting in a reduced processing cost, temperature in the center part of the bread is properly lowered so that the bread can be cut well without developing a rough cut surface.

### TECHNICAL FIELD

The present invention relates to a method and apparatus for cooling bread just after baked to be transferred to next processes for wrapping, refrigerating, and so on, specifically a cooling method and apparatus with which it can be achieved to reduce periods of time for cooling, improve eating quality by preventing evaporation of water contained in the bread, and improve process yield by performing the cooling while transferring the bread on a conveyor in a cooling room in which temperature and humidity are controlled.

### BACKGROUND ART

Vacuum cooling has been utilized as a method for cooling bread such as loaves, etc. quickly just after they are baked. Vacuum cooling is a method of cooling food by allowing the water contained in the food to evaporate in vacuum and depriving of the food the latent heat of evaporation of water, which enable quick cooling.

For example, patent literature 1 (JP-A-H06-269266) adopted this type of cooling. In the method disclosed in patent literature 1, food is accommodated in a cooling chamber to perform vacuum cooling, and when air is introduced in the chamber after the temperature of the food lowered to a prescribed temperature, the air is introduced while sterilizing bacteria or funguses in the air with steam to prevent bacteria or funguses from adhering to the food.

However, vacuum cooling brings about secondary coagulation due to deprival of water contained in the food when it is cooled, resulting in deteriorated quality of food. Further, in the case of cooling food in a vacuum chamber, it is difficult to perform the process continuously, and operation efficiency can not be so good.

There has been proposed a method to cool under normal pressure easily and quickly.

For example, an apparatus for cooling food under normal pressure is disclosed in patent literature 2(JP-A-H06-217750).

In the apparatus, a cold moisture circulation passage is formed by connecting with a pipe line the air space in a water tank which reserves cold water to a chamber for cooling food, an ejector is provided in the circulation passage for generating negative pressure by injecting cold water, and cold moisture is circulated between the air space in the tank and the cooling chamber by the negative pressure. With this configuration, cold air of high humidity in the air space in the water tank is supplied to the cooling chamber through the passage and the latent heat of vaporization of water contained in the bread is deprived of the food to effect cooling of the same.

By this method, since the food is not exposed to vacuum, physical change is practically non-existent in the food and its quality is maintained.

In patent literature 3(JP-A-2002-318051) is disclosed a cooling apparatus with which two types of cooling, cooling by cold air under normal pressure and cooling under vacuum, can be performed in the same chamber.

The apparatus has a cooling chamber of hermetical construction capable of being used for cooling by cold air under normal pressure and cooling under vacuum and the cooling chamber is provided with incidental equipment necessary for cooling by cold air under normal pressure and cooling under vacuum.

However, those cooling methods and apparatuses are of batch processing system, and the cooling operation is stopped when introducing food to be cooled in and out, so operation efficiency is not so good.

Recently, a method is adopted in which food is placed on a conveyor to be brought in a hermetical cooling chamber to be transferred to a spiral or vertical conveyor part in the cooling chamber to be cooled in the chamber. The transfer speed of the conveyor is adjusted so that the food resides in the chamber for a period of time necessary for cooling the food and leaves the chamber to be transferred to succeeding processes such as wrapping, refrigeration, etc. By this, food can be cooled while continuously transferring and as a result operation efficiency is greatly improved.

An example of the method of cooling baked or roasted food by use of a spiral conveyor will be explained with reference to FIG. 10. In FIG. 10, reference symbol f is bread such as a loaf just after it is baked in an oven not shown in the drawing and having a surface temperature of about 95° C. and inner temperature (temperature of the central part thereof) of 77° C. Reference numeral 01 is a cooling chamber of hermetical structure for cooling the bread f just after baked, a spiral conveyor 02 on which the bread f just after baked is placed to be transferred in the chamber is provided in the cooling chamber 01, and a cooling device 03 in which outside air o is introduced and water is showered to be evaporated to cool the introduced outside air o by the latent heat of vaporization of water and highly humidify the air o.

The spiral conveyor 02 has a spiral part in the cooling chamber 01 and the bread f just after baked placed on the conveyor enters the cooling chamber 01 from the entrance 01a, and the transfer speed of the conveyor 02 is adjusted so that the bread f just after baked resides in the cooling chamber 01 for a period of time necessary to cool the bread f just after baked.

The cooling device 03 has in its duct 04 a fan 05 and a showering device 06 for showering water, outside air o passing through the duct 04 is showered with water, the showered water is evaporated, the introduced outside air o is cooled by the latent heat of vaporization of the showered water and becomes highly humid air to be supplied to the cooling chamber 01.

With the configuration, a cooling space is formed in the cooling chamber filled with the outside air o cooled by the cooling device 03 and made highly humid with the water vapor evaporated in the cooling device 03. The bread f just after baked is transferred in the cooling chamber 01 in the state it is placed on the spiral conveyor 02, resides in the cooling chamber 01 for about 120 minutes to be cooled by the low temperature and highly humid air in the cooling chamber 01 in a state evaporation of water from the surface of the bread f just after baked is suppressed in order to prevent reduction of process yield, and then leaves the cooling chamber from the exit 01b of the cooling chamber 01.

FIG. 11 illustrates another example of cooling system of bread just after baked provided with a spiral conveyor. In this apparatus, a refrigerator 07 is provided instead of the cooling device 03 of FIG. 10. In FIG. 11, the air in the cooling chamber 01 is cooled to a temperature of about 15˜20° C. by the refrigerator 07 and a circulation flow c of low temperature air is formed in the cooling chamber 01.

FIG. 12 illustrates still another example of cooling system of bread just after baked provided with a vertical conveyor. In FIG. 12, reference numeral 08 is a vertical conveyor disposed in the cooling chamber 01, the bread f just after baked placed on the conveyor enters the cooling chamber 01 from the entrance 01a thereof, and the transfer speed of the vertical conveyor is adjusted so that the bread f just after baked resides in the cooling chamber 01 for a period of time necessary to cool the bread f just after baked.

In FIG. 12, the cooling chamber 01 is provided with a outside air supply passage 09 to introduce outside air o. In the passage 09 is provided a cooling device 03 for showering water to cool outside air o with the latent heat of vaporization of the showered water and at the same time to make the introduced air o to be highly humid air. By this, an atmosphere of low temperature, high humidity is generated in the cooling chamber and in addition a refrigerator 07 is provided in the cooling chamber to further cool the air in the chamber.

However, it is difficult for the cooling device 03 of FIG. 10 to perform fine mixing of water with outside air o, and therefore practically cooling of outside air o while allowing water to evaporate hardly occurs.

Average temperature of outside air o is about 15° C. in winter and 30° C. in summer. Actually, as outside air is cooled little in the cooling device 03 and its temperature is near that of outside air, so in summer it is near 30° C. and can not cool the bread f just after baked effectively. Further, relative humidity in the cooling chamber becomes not higher than 25˜35%, so evaporation of water from the surface of the bread f just after baked cannot be suppressed and process yield reduces.

Further, in the prior art of FIG. 11, as the humidity in the cooling chamber 01 is not controlled, evaporation of water from the bread f just after baked occurs and the weight of the bread f just after baked reduces at the exit 01b to 97 to 98% of that at the entrance 01a, as a result eating quality is deteriorated to such an extent an eater feels dry and crumbling.

There may be a countermeasure for preventing evaporation of water from the bread f just after baked in which the bread is cut into pieces of proper size and every piece is wrapped before cooling, but if the bread is cut when it is hot, the cut surface becomes rough and appearance and eating quality are deteriorated.

Further, with the prior art of FIG. 12, even when water is showered in the cooling device 03, humidity is not increased actually like in the case of the apparatus of FIG. 10, and outside air o introduced into the cooling chamber 01 where the hot bread just after baked is transferred into is heated by the hot bread and reduced in relative humidity, so evaporation of water from the surface of the bread can not be suppressed.

### DISCLOSURE OF INVENTION

The object of the present invention is made in light of the problems experienced in the prior arts mentioned above and its object is to provide a method and apparatus for cooling bread just after it is baked, in which, when the bread just after baked is cooled to be transferred to next processes for wrapping, refrigerating, etc., evaporation of water in said cooling process is prevented in order to maintain eating quality and increase process yield. Specifically, said cooling process is controlled to achieve process yield of 99.4-99.6% with which best eating quality is attained.

Another object of the invention is to lower properly the temperature of center part of the bread so that the bread can be cut well without developing a rough cut surface and also to reduce the cooling time.

To attain the objects, the first composition of method of the present invention is a method for cooling bread just after baked in which the bread just after it is baked is introduced into a cooling chamber on a conveyor to be carried out of the cooling chamber after the bread is cooled by allowing it to reside therein for a period of time needed for cooling,

wherein inside temperature of said cooling chamber is maintained at 5-20° C., preferably at 10-20° C., and

the transfer space surrounding the transfer passage of said conveyor is allowed to be a space of highly humid cooling space of relative humidity of 60% or higher by supplying hydrated air to an upstream side part of transfer direction of said conveyor where temperature is highest in the cooling chamber by virtue of the heat of the bread just after baked to form a region of high absolute humidity around the bread transferred in the cooling chamber.

With the methods of prior arts shown in FIG. 10-12, the temperature of atmosphere around the bread just after baked raised by the heat of the bread when the bread just after baked is transferred into the cooling chamber, as a result relative humidity is lowered resulting in quickened evaporation of water from the bread just after baked. With the first composition of method of the invention, by effusing hydrated air toward an upstream side part of the transfer direction of the conveyor where temperature is highest in the cooling chamber by virtue of the heat of the bread just after baked, a region of high absolute humidity is formed around the bread.

Since absolute humidity rises steeply as temperature rises for the same relative humidity, an atmosphere of high absolute humidity can be formed by effusing hydrated air to a high temperature region. By this, relative humidity of the transfer space surrounding the transfer passage of the conveyor does not fall with the fall of temperature of the bread as it is transferred downstream, so the bread can be cooled in an atmosphere of high relative humidity.

In said first composition, preferably said transfer space surrounding the transfer passage of the conveyor is maintained to be of relative humidity of 90-100%. This is because when relative humidity in the transfer space is 100% and there still remains water, an amount of water larger than necessary will be absorbed into the bread and the bread will become sticky paste resulting in deteriorated eating quality. The first composition of method of the invention is better suited for ordinary bread.

For a large-size, mountain-like-shaped bread such as English bread, loaf bread, etc. of weight of 500 g or over, it takes time for cooling, and as the surface of the bread to effect heat transfer from the bread is large, it is difficult to suppress evaporation of water from the bread in the case of one-stage cooling like the first composition of method of the invention, and there has happened a case the process yield reduces by over 2.5%. This problem can be solved by the second composition of method of the present invention.

The second composition of method of the present invention is a method of cooling bread just after baked in which the bread just after it is baked is introduced into a cooling chamber on a conveyor to be carried out of the cooling chamber after the bread is cooled by allowing it to reside therein for a period of time needed for cooling,

wherein said cooling chamber is partitioned into a quick cooling region maintained at a low temperature for cooling the surface of the bread quickly and a slow cooling region maintained at a temperature higher than that of said quick cooling region for cooling the center part of the bread slowly,

said bread just after baked is first introduced into said quick cooling region maintained at low temperature,

a region of high absolute humidity is formed in said quick cooling region around the bread by supplying hydrated air to an upstream side part of transfer direction of said conveyor where temperature is highest in said quick cooling region by virtue of the heat of the bread just after baked so that the bread just after baked is cooled quickly while thus allowing the transfer space surrounding the transfer passage of said conveyor to be of an atmosphere of high relative humidity (high relative humidity means relative humidity of 60-100% here),

then the bread is transferred from said quick cooling region to said slow cooling region,

a region of high absolute humidity is formed in said slow cooling region around the bread by supplying hydrated air to an upstream side part of transfer direction of said conveyor where temperature is highest in said slow cooling region by virtue of the heat of the bread just after transferred to said slow cooling region so that the bread is humidified while thus allowing the transfer space surrounding the transfer passage of said conveyor in said slow cooling region to be of an atmosphere of high relative humidity higher than that of said quick cooling region.

In the second composition of method of the invention, preferably the transfer space in the quick cooling region is maintained at 5-15° C. in temperature and 60-80% in relative humidity, and the transfer space in the slow cooling region is maintained at 15-25° C. in temperature and 80-100% in relative humidity.

The surface of the bread just after it is baked in an oven is about 95° C. This bread just after baked is cooled quickly in the quick cooling region maintained at 5-15° C. in order to secure large temperature difference between the atmosphere and the surface of the bread while forming a region of high absolute humidity around the bread by effusing hydrated air in an upstream side part of the transfer direction of the conveyor where temperature is highest in the quick cooling region, by which the transfer space surrounding the transfer passage is maintained to be a highly humid atmosphere, preferably an atmosphere of relative humidity of 60-80% and evaporation of water from the bread is suppressed.

Then the bread is transferred into the slow cooling region to humidify the same. That is, the bread is about 15-25° C. on the surface thereof and about 35-45° C. at the center part thereof at the entrance to the slow cooling region. This bread is humidified in an atmosphere of relative humidity of 80-100% while preventing evaporation of water from the surface of the bread with the transfer space in the slow cooling region being maintained at a temperature higher than that of the quick cooling region, preferably maintained at 15-25° C. in order to eliminate temperature difference between the atmosphere and the surface of the bread, and humidification processing is performed for the bread to absorb moisture in the highly humid atmosphere from the surface thereof to recover water evaporated in the quick cooling region.

The apparatus of the present invention comprises:

a cooling chamber in which cooling space is formed,

a conveyor for carrying bread just after baked placed thereon into and out of said cooling chamber, and

composed such that the bread just after baked is allowed to reside in said cooling chamber for a period of time needed for cooling by adjusting transfer speed of said conveyor, wherein are provided;

a refrigerating machine in said cooling chamber to blow out cooling air stream toward the starting position of transfer of the bread in the cooling chamber, and

a humidifier to effuse hydrated air toward an upstream side part of transfer direction of said conveyor where temperature is highest in the cooling chamber by virtue of the heat of the bread just after baked.

In the apparatus of the invention, the hydrated air effused from the humidifier is heated by heat transfer including thermal radiation from the bread just after baked having a large amount of heat and the water in the hydrated air is evaporated, and an atmosphere of high absolute humidity is formed around the bread just after baked. Once the atmosphere of high absolute humidity is formed, high relative humidity is maintained even when the temperature of the atmosphere falls in the downstream zone of the transfer passage. By maintaining the transfer space surrounding the bread transferred on the conveyor at high relative humidity of 60% or higher in this way, quick cooling of the bread after just baked is possible while suppressing evaporation of water from the bread.

In the invention, it is preferable to use as the conveyor a spiral conveyor or vertical conveyor.

In the apparatus of the invention, when a spiral conveyor is used, it is suitable that a transfer space is formed to transfer the bread just after baked vertically spirally on the spiral conveyor, the humidifier is located near the starting part of transfer in the transfer space, and the refrigerating machine is composed such that the cold air stream blown out therefrom is directed to the downstream zone of the transfer passage. By this, the hydrated air can be effused toward a part where the amount of heat stored in the bread is largest and the space around the bread can be maintained at high relative humidity of 60% or higher.

Further, by composing the refrigerating machine so that the cold air generated by the refrigerating machine to flow downstream in the transfer direction, the cold air stream when it is lowest in temperature contacts the bread just after baked when it is highest in temperature, and quick cooling of the surface of the bread is possible.

In the apparatus of the invention, when a vertical conveyor is used, it is suitable that the humidifier is located near the part where the horizontal transfer part just after it enters into said cooling chamber continues to the first vertical part of the vertical conveyor, and the refrigerating machine is composed such that the cold air stream blown out therefrom is directed from the entrance side to the exit side of the vertical conveyor. By this, the hydrated air can be effused toward a part where the amount of heat stored in the bread is largest and the cold air stream just after it is blown out from the refrigerating machine and lowest in temperature can be brought to contact with the bread just after baked and highest in temperature, and quick cooling of the surface of the bread is possible.

The apparatus is better suited for ordinary bread.

For a large-size, mountain-like-shaped bread such as English bread, loaf bread, etc. of weight of 500 g or over, it takes time for cooling, and as the surface of the bread to effect heat transfer from the bread is large, it is difficult to suppress evaporation of water from the bread in the case of one-stage cooling like the first composition of method of the invention, and there has happened a case the process yield reduces by over 2.5%.

To solve this problem, the apparatus of the invention is composed such that said cooling chamber is partitioned into a quick cooling region for cooling the surface of the bread quickly and a slow cooling region for cooling the center part of the bread slowly,

said conveyor is arranged such that it first enters into said quick cooling region and then advances out of the quick cooling region to enter into said slow cooling region, and said refrigerating machine and humidifier are provided in each of said quick cooling region and slow cooling region.

In the quick cooling region, the cold air stream blown out from the refrigerating machine is brought into contact with the bread just after baked while the hydrated air effused from the humidifier is heated by heat transfer including thermal radiation from the bread just after it is baked and highest in temperature and the water in the hydrated air is evaporated to form an atmosphere of high absolute humidity around the bread, so the bread can be cooled quickly while suppressing evaporation of water from the bread.

The bread just after baked cooled in the quick cooling region is transferred on the conveyor into the slow cooling region, here again hydrated air is effused in the starting part of transfer in the slow cooling region, so the transfer space around the bread can be maintained at relative humidity higher than that of the quick cooling region, and absorption of moisture to the bread is promoted here to recover the moisture evaporated from the bread in the quick cooling region. The bread can be cooled here until the temperature of the center part thereof becomes 25° C.

By partitioning the cooling chamber into a quick cooling region and a slow cooling region and performing two-stage cooling in this way, bread of large size can be cooled while suppressing evaporation of water from the bread.

According to the first composition of the method of the invention, the space around the transfer passage of the bread just after baked can be made to be a highly humid cooling space having relative humidity of 60% or higher by maintaining cooling chamber at 5-20° C., preferably 10-20° C. and forming a region of high absolute humidity around the transfer passage of the bread through supplying hydrated air in the upstream part of the transfer direction of the conveyor where temperature is highest in the cooling chamber heated with the hot bread just transferred into the cooling chamber, so that evaporation of water from the bread just after baked can be suppressed and reduction in process yield caused by cooling can be limited to a minimum and moist and glutinous eating quality of the bread can be maintained with reduced processing cost.

Further, moisture retention agent is not needed which causes odor and bitter taste, etc. resulting in deteriorated eating quality.

In a system in which the bread just after it is baked is left to natural cooling, the temperature at the center part of the bread is not lowered enough (usually lowered until about 38° C.) because it cannot be cooled under the environmental temperature in the factory, cut surface is rough when the bread is cut, external appearance and eating quality is deteriorated. By the method of the present invention, as the inside temperature of the cooling chamber is maintained at low temperature of 5-20° C., reduction of cooling period is possible, temperature of 25° C. is secured at the center part of the bread, as a result the bread can be cut well without developing a rough cut surface.

With the system of natural cooling, it took 2-3 hours to cool the bread until its center part temperature becomes 38° C., but with the method of the present invention, it took only 80 minutes to cool the bread until its center part temperature becomes 25° C.

Further, according to the second composition of method of the present invention, cooling of bread just after baked with evaporation of water from the bread being suppressed is possible, reduction in process yield caused by cooling can be limited to a minimum resulting in reduction in processing cost while maintaining moist and glutinous eating quality, by partitioning a cooling chamber into a quick cooling region maintained at low temperature for cooling quickly the surface of the bread and a slow cooling region maintained at temperature higher than that of the quick cooling region for cooling slowly the center part of the bread, transferring first the bread just after baked into the quick cooling region maintained at low temperature in which the bread just after baked is cooled quickly while allowing the transfer space surrounding the transfer passage of the conveyor to be an atmosphere of high relative humidity by forming a region of high absolute humidity around the bread after just baked through supplying hydrated air in an upstream side part of the transfer direction of the conveyor where temperature is highest in the quick cooling region by virtue of the heat of the bread just after baked, then transferring the bread from the quick cooling region to the slow cooling region, in which the bread is humidified while allowing the transfer space surrounding the transfer passage of the conveyor to be an atmosphere of relative humidity higher than that of the quick cooling region by forming a region of high absolute humidity around the bread through supplying hydrated air in an upstream side part of the transfer direction of the conveyor where temperature is highest in the slow cooling region by virtue of the heat of the bread just after transferred from the quick cooling region to the slow cooling region.

Further, according to the apparatus of the present invention, inner atmosphere of the cooling chamber can be maintained low in temperature and high in humidity suitable for cooling bread just after baked, by proving in the cooling chamber a refrigerating machine for blowing out cold air stream toward the starting part of transferring the bread just after baked in the cooling chamber and a humidifier for effusing hydrated air to an upstream side part of the transfer direction of the conveyor where temperature is highest in the cooling chamber by virtue of the heat of the bread just after baked introduced into the cooling chamber. By this, cooling of bread just after baked can be performed with evaporation of water from the bread being suppressed and reduction in process yield being suppressed to a minimum, as a result moist and glutinous eating quality can be maintained with cooling period being reduced.

Further, in the apparatus of the invention, by partitioning a cooling chamber into a quick cooling region for cooling quickly the surface of the bread and a slow cooling region for cooling slowly the center part of the bread, providing a conveyor such that it enters first into the quick cooling region and then advances therefrom into the slow cooling region, and providing a refrigerating machine and humidifier in each of the quick cooling region and slow cooling region, quick cooling becomes possible by securing large temperature difference between the temperature of the quick cooling region and that of the surface of the bread just after baked, and in the slow cooling region temperature difference between the temperature of the slow cooling region and that of the surface of the bread is eliminated and bread can be humidified. By allowing each of the regions to be highly humid atmosphere, large-size bread can also be cooled while preventing evaporation of water from the bread, as a result process yield is increased and good eating quality is maintained.

### BRIEF DESCRIPTION OF DRAWINGS

FIG. 1 is a schematic representation of overall structure of the first embodiment of the present invention.

FIG. 2 is a view in the direction of arrows II-II in FIG. 1.

FIG. 3 is a schematic diagram showing the control system of the first embodiment.

FIG. 4 is a schematic representation of overall structure of the second embodiment of the present invention.

FIG. 5 is a schematic representation of overall structure of the third embodiment of the present invention.

FIG. 6 is a schematic representation of overall structure of the fourth embodiment of the present invention.

FIG. 7 is a graph showing temperature and humidity transition of the fourth embodiment.

FIG. 8 is a schematic diagram showing the control system of the fourth embodiment.

FIG. 9 is a schematic representation of overall structure of the fifth embodiment of the present invention.

FIG. 10 is a schematic representation of structure of an example of baked bread cooling system of prior art.

FIG. 11 is a schematic representation of structure of another example of baked bread cooling system of prior art.

FIG. 12 is a schematic representation of structure of still another example of baked bread cooling system of prior art.

### BEST MODE FOR CARRYING OUT THE INVENTION

A preferred embodiment of the present invention will now be detailed with reference to the accompanying drawings. It is intended, however, that unless particularly specified, dimensions, materials, relative positions and so forth of the constituent parts in the embodiments shall be interpreted as illustrative only not as limitative of the scope of the present invention.

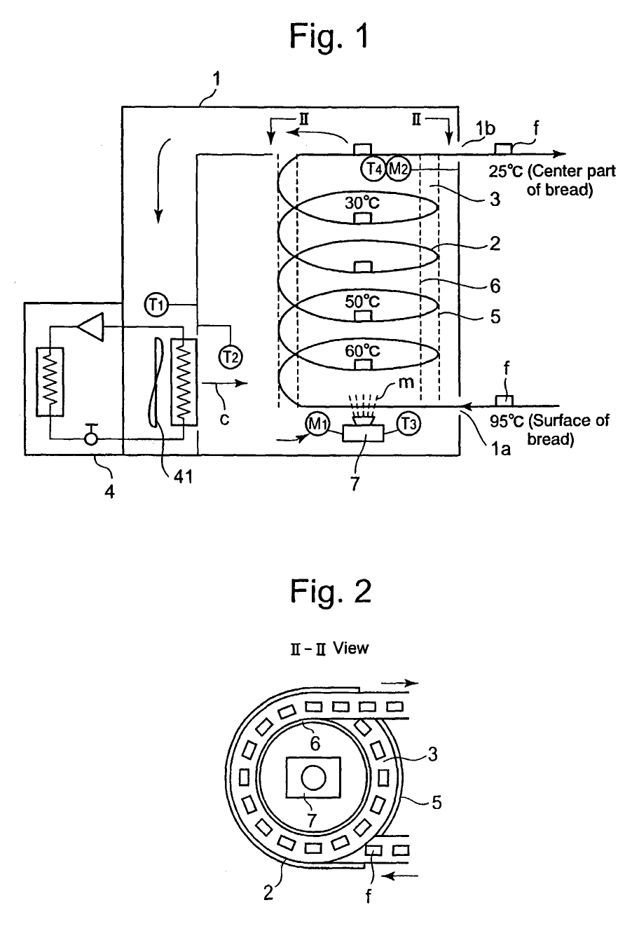

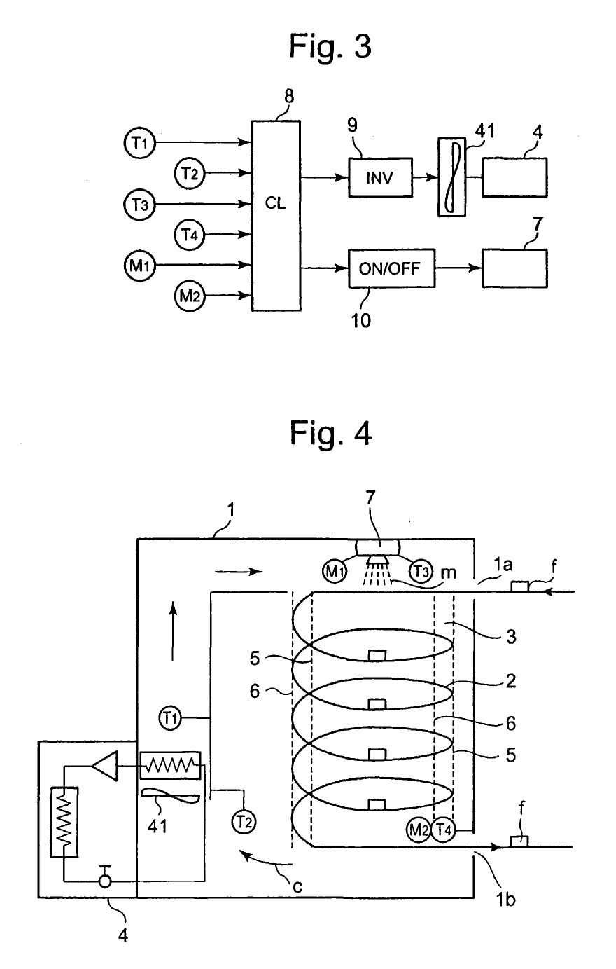

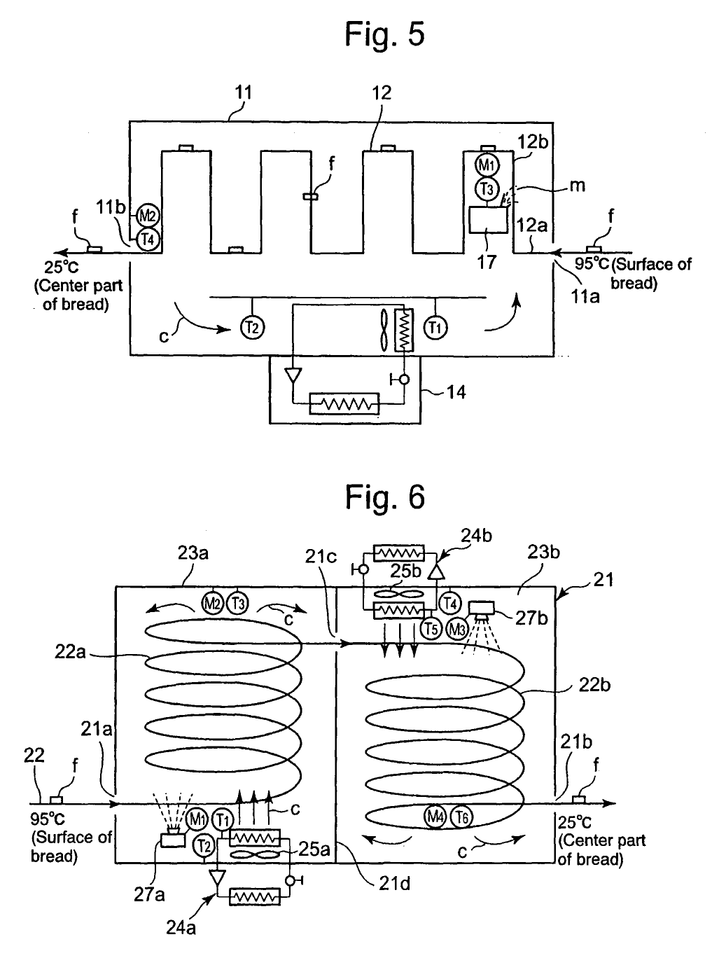

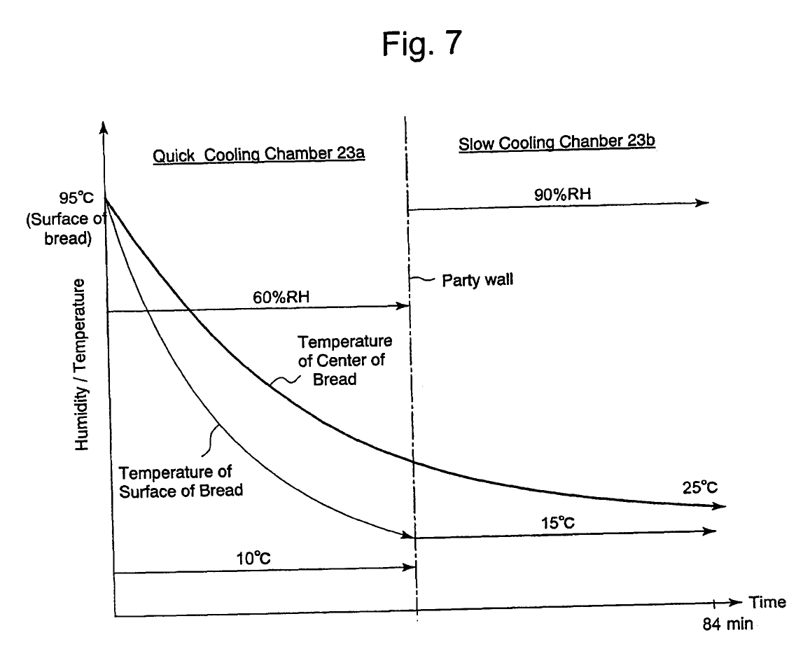

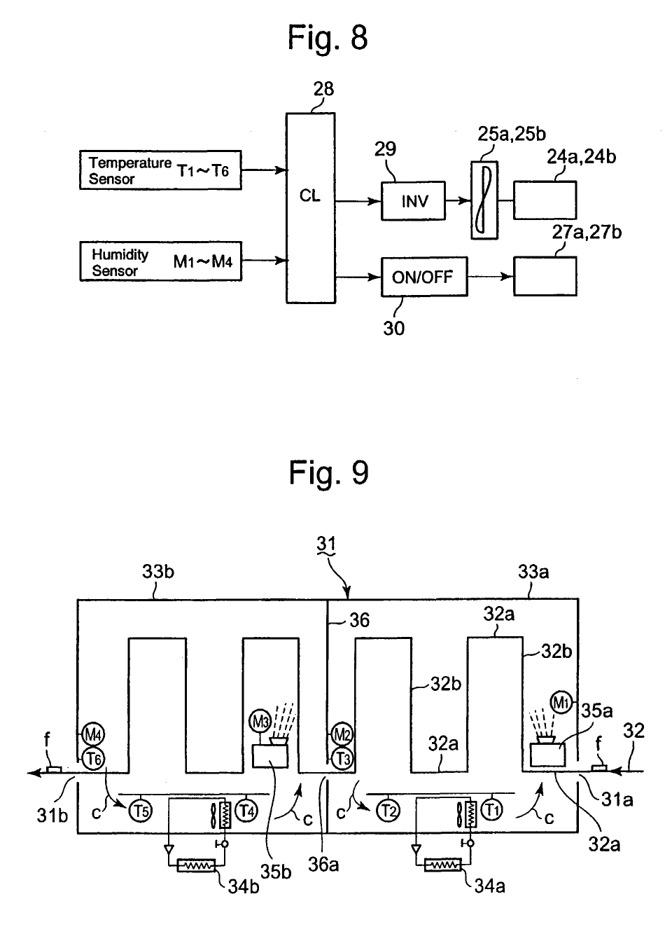

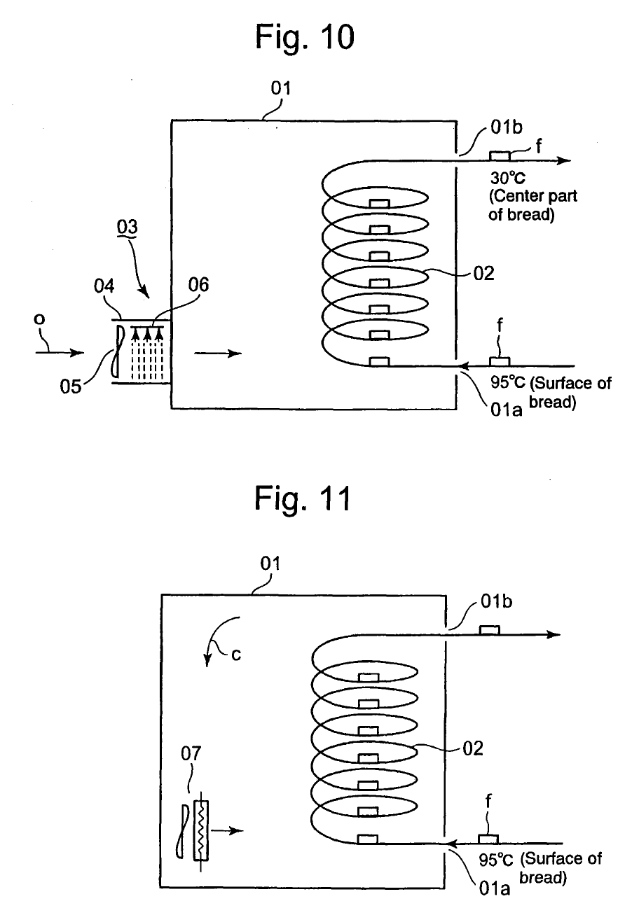

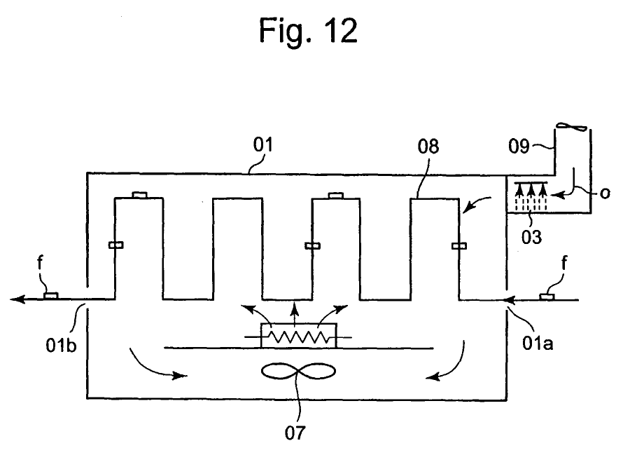

FIG. 1 is a schematic representation of overall structure of the first embodiment of the present invention, FIG. 2 is a view in the direction of arrows II-II in FIG. 1, FIG. 3 is a schematic diagram showing the control system of the first embodiment, FIG. 4 is a schematic representation of overall structure of the second embodiment of the present invention, FIG. 5 is a schematic representation of overall structure of the third embodiment of the present invention, FIG. 6 is a schematic representation of overall structure of the fourth embodiment of the present invention, FIG. 7 is a graph showing temperature and humidity distribution of the fourth embodiment, FIG. 8 is a schematic diagram showing the control system of the fourth embodiment, and FIG. 9 is a schematic representation of overall structure of the fifth embodiment of the present invention.

### The First Embodiment

Referring to FIG. 1-3 showing the first embodiment of the present invention, reference numeral 1 is a cooling chamber to cool bread just after baked, 2 is a spiral conveyor located in the cooling chamber such that bread f just after baked having surface temperature of about 95° C. is placed on the conveyor at the outside of the cooling chamber 1 to be introduced into the cooling chamber 1 from an entrance 1a and transferred spirally upward in the cooling chamber 1 and then carried out of the cooling chamber 1 from an exit 1b.

Reference numeral 4 is a refrigerating machine for cooling the atmosphere in the cooling chamber 1 to generate a circulating cold air flow c of about 10° C. By this the inside space of the cooling chamber 1 is maintained at 12-15° C. Reference numeral 5 and 6 are party walls disposed vertically inside and outside of the spiral part of the spiral conveyor 2 to form a donut-like transfer space 3 surrounding the spiraling transfer surface of the conveyor 2.

Reference numeral 7 is a humidifier located near the bottom of the spiral conveyor 2 to be positioned near the bottom of the transfer space 3 where temperature is highest due to the heat of the bread f introduced just after baked. The atmosphere in the bottom part of the transfer space 3 is heated to about 60° C. by heat transfer from the bread just after baked including thermal radiation. By locating the humidifier 7 here to effuse hydrated air m, air of high absolute humidity can be generated. Absolute humidity increases steeply with increase in temperature for the same relative humidity, for example, absolute humidity is 12.0 mmg/m³ at temperature of 20° C. and relative humidity of 70%, whereas absolute humidity is 27.4 mmg/m³ at temperature of 35° C. and relative humidity of 70%.

The hydrated air effused from the humidifier 7 is heated by heat transfer from the bread f just after baked including thermal radiation and the water vapor generated forms an atmosphere of high absolute humidity around the humidifier 7. By this, relative humidity of 90-100% is maintained in downstream zones of the transfer space 3. When relative humidity is 100% and there still remains water in the atmosphere, an amount of water larger than necessary will be absorbed into the bread and the bread will become sticky paste resulting in deteriorated eating quality.

In the apparatus configured like this, cold air c is blown out from the refrigerating machine 4 toward the humidifier 7 to allow cold air circulation c to be generated. The cold air c cools the bread f just after baked quickly due to large temperature difference between the temperature of the cold air and that of the bread f, the cold air rises in temperature and flows upward in the transfer space 3, thus said air circulation is generated. The bread f transferred on the spiral conveyor 2 decreases in temperature as it is transferred upward in the transfer space 3. In the transfer space 3 the atmosphere is made humid with high relative humidity from the bottom until top of the transfer space 3, so the bread f just after baked is cooled in the space 3 while it is exposed to the atmosphere of high humidity and evaporation from the surface of the bread is suppressed until it reaches near the exit of the cooling chamber 1.

Further, as shown in FIG. 1 and FIG. 3, temperature sensors T1 and T2 are provided respectively in the upstream side and downstream side of the refrigerating machine 4, temperature sensors T3, T4, and humidity sensors M1, M2 are provided in the bottom and top of the transfer space 3 respectively. The temperature and humidity in the cooling chamber 1 can be controlled by a controller 8 through controlling a fan 41 of the refrigerating machine 4 by controlling an inverter 9 or through controlling the humidifier 7 by on/off control of an ON/OFF switch 10.

It is also suitable to on/off-control or step-control the fan 41 instead of said inverter controlling. It is also suitable to provide a plurality of refrigerating machines and control the number of refrigerating machines operated. It is also suitable to provide a plurality of humidifiers and control the number of humidifiers operated. Thus the temperature and humidity in the cooling chamber 1 are controlled to prescribed values by optimally controlling the fan 41 of the refrigerating machine 4 and the humidifier 7.

According to the first embodiment, since the area surrounding the bread f just after baked in the cooling chamber can be maintained to be a highly humid atmosphere, evaporation of water from the bread can be suppressed, reduction in process yield caused by cooling can be limited to a minimum, and moist and glutinous eating quality of bread can be maintained.

Further, as the temperature in the cooling chamber is controlled by the refrigerating machine, cooling period can be reduced and the temperature in the center part of the bread can be lowered to below 25° C. Therefore, the bread can be cut well without developing a rough cut surface.

Further, as the temperature in the cooling chamber 1 is automatically controlled, labor-saving is attained, and stability in quality of bread in mass production and improvement in sanitary supervision can be achieved by the cooling.

### The Second Embodiment

Next, the second embodiment of the invention will be explained with reference to FIG. 4. In FIG. 4, the second embodiment is composed such that the entrance 1a of the spiral conveyor 2 is provided at the upper part of the cooling chamber 1 and the exit 1b is provided at the lower part of the cooling chamber 1, whereby the bread f just after baked is transferred downward from above, and the humidifier 7 is located at the upper part of the transfer space 3 formed by the party walls 5 and 6, and the refrigerating machine 4 is positioned so that the circulation flow c generated by the refrigerating machine 4 flows downward from above the spiral conveyor 2 contrary to the case of FIG. 1.

The control system of second embodiment is the same as that of the first embodiment shown in FIG. 3.

With the configuration, the hot bread f just after baked introduced into the cooling chamber near the upper end part of the transfer space 3 is cooled quickly by the cold air circulation flow c blown out from the refrigerating machine 4 to contact the hot bread f, and the atmosphere around the bread f just after baked is heated by heat transfer from the bread f just after baked including thermal radiation. The cold air thus raised in its temperature is raised in its humidity by the hydrated air m effused from the humidifier 7 to generate an atmosphere of high absolute humidity and flows downward in the direction of transfer of the bread.

The bread f is cooled while transferred downward on the spiral conveyor 2, and as the transfer space 3 surrounding the bread f is rendered to be highly humid in relative humidity, evaporation of water contained in the bread can be suppressed.

In this way, according to the second embodiment, the bread f just after baked introduced into the upper part of the cooling chamber 1 is cooled quickly by the heat exchange with the circulating cold air c, an atmosphere of high absolute humidity is generated by adding hydrated air to the cold air c risen in temperature, and the atmosphere surrounding the bread f in the transfer space 3 is maintained always to be highly humid in relative humidity, so that cooling period can be reduced, process yield caused by cooling can be limited to a minimum, and good moist eating quality of bread can be maintained.

### The Third Embodiment

Next, the third embodiment of the invention will be explained with reference to FIG. 5. The third embodiment is an example in which a vertical conveyor is used for transferring the bread f just after it is baked. In FIG. 5, reference numeral 12 is a vertical conveyor provided in the cooling chamber 11. The bread f after just baked is introduced from an entrance 11a of the cooling chamber 11 and carried out from an exit 11b thereof. Reference numeral 14 is a refrigerating machine for generating a cold air circulation flow c so that it flows in the direction the same as the transfer direction of the vertical conveyor 11 from the entrance 11a toward the exit 11b. Reference numeral 17 is a humidifier located near the part where the first horizontal transfer part 12a near the entrance 11a continues to the first vertical transfer part 12b. The control system of third embodiment is the same as that of the first embodiment shown in FIG. 3.

With the configuration, the bread f just after baked introduced from the entrance 11a into the cooling chamber 11 is cooled quickly by the heat exchange with the cold air circulation flow c brown out from the refrigerating machine 14. On the other hand, the cold air heated by the bread and raised in its temperature is added with hydrated air m effused from the humidifier 17 to form an atmosphere of high absolute humidity. The atmosphere of high absolute humidity moves toward the downstream side of the vertical conveyor 12 and as a result the transfer space surrounding the bread f is maintained always to be humid in relative humidity.

According to the third embodiment like this, by allowing the transfer direction of the bread f to coincide with the flow direction of the cold air circulation c, the cold air just after it is blown out from the refrigerating machine 14 blows over the bread f in the region where the bread f is highest in temperature, as a result cooling effect is increased. Further, there is an advantage that the bread f just after baked can be cooled while being surrounded by an atmosphere of high relative humidity with the highly humid atmosphere around the bread f being not disturbed.

In this way, the bread f just after baked can be cooled quickly to have a temperature of 25° C. at its center part without evaporation of water from the bread f, so that reduction in process yield caused by cooling can be limited to a minimum and good eating quality of moist and glutinous taste can be maintained.

### The Fourth Embodiment

It is difficult to cool a large-size, mountain-like-shaped bread such as English bread, loaf bread, etc. of weight of 500 g or over by one-stage cooling like the first to third embodiment while suppressing evaporation of water from the bread because of elongated time required for cooling and the large surface area of the bread. Such problems can be solved by the fourth embodiment explained hereafter, in which two cooling chambers are arranged in series. The fourth embodiment of the invention will be explained with reference to FIG. 6-8. In FIG. 6, reference numeral 21 is a cooling house, a spiral conveyor 22 is provided in the cooling house 21 such that a transfer passage is formed to introduce the bread f just after baked from an entrance 21a and carry out the bread from an exit 21b. The cooling house 21 is partitioned with a party wall 21d into a quick cooling chamber 23a for cooling the surface of the bread quickly in the upstream side and a slow cooling chamber 23b for cooling the center part of the bread slowly in the downstream side of the transfer passage.

In the quick cooling chamber 23a is provided an ascending transfer part 22a of the spiral conveyor 22 to rise upward from the entrance 21a, and a refrigerating machine 24a and a humidifier 27a are located below the ascending transfer part 22a. In the slow cooling chamber 23b is formed a descending transfer part 22b continuing to the ascending transfer part 22a through a opening 21c of the party wall 21d, and a refrigerating machine 24b and a humidifier 27b are located above the descending transfer part 22b.

As shown in FIG. 6 and FIG. 8, a temperature sensor T1 and T2 are provided respectively at the upstream and downstream side of the refrigerating machine 24a of the quick cooling chamber 23a, a temperature sensor T4 and T5 are provided respectively at the upstream and downstream side of the refrigerating machine 24b of the slow cooling chamber 23b, further a humidity sensor M1 is provided at the lower end part of the ascending transfer part 22a, a temperature sensor T3 and a humidity sensor M2 are provided at the upper end part of the ascending transfer part 22a, a humidity sensor M3 is provided at the upper end part of the descending transfer part 22b, and a humidity sensor M4 and a temperature sensor T6 are provided at the lower end part of the descending transfer part 22b. Temperature and humidity in the cooling house 21 can be controlled through inverter-controlling a fan 25a and 25b of the refrigerating machine 24a and 24b respectively by a controller 28 based on detected values of these sensors or through on/off control of the humidifier 27a and 27b by an ON/OFF switch 30.

It is also suitable to on/off-control or step-control the fan 25a and 25b instead of said inverter controlling. It is also suitable to provide a plurality of refrigerating machines and control the number of refrigerating machines operated. It is also suitable to provide a plurality of humidifiers and control the number of humidifiers operated. Thus the temperature and humidity in the cooling house 1 are controlled to prescribed values by optimally controlling the refrigerating machines 24a and 24b, and the humidifiers 27a and 27b.

FIG. 7 is a graph showing transition of temperature and humidity in the quick cooling chamber 23a and slow cooling chamber 23b of the cooling house 21 of the fourth embodiment. As shown in FIG. 7, the temperature of the quick cooling chamber 23a is maintained at 10° C. by the cold air c blown out from the refrigerating machine 24a and the humidity maintained at 60% relative humidity by the hydrated air effused from the humidifier 27a. In the slow cooling chamber 23b, the temperature is maintained at 15° C. by the cold air c blown out from the refrigerating machine 24b and the humidity is maintained at 90% relative humidity by the hydrated air effused from the humidifier 27b.

With the configuration, the bread f just after baked introduced on the vertical conveyor 22 from the entrance 21a into the quick cooling chamber 23a has a surface temperature of about 95° C. and temperature difference between this and the atmosphere temperature of 10° C. in the quick cooling chamber 23a is large, so the bread f is cooled quickly. On the other hand, the atmosphere surrounding the transfer passage near the entrance 21a is heated by heat transfer from the bread including thermal radiation and added with the hydrated air effused from the humidifier 27a to form an atmosphere of high absolute humidity.

Then, the bread f just after baked is transferred to the ascending transfer part 22a to be moved upward. Since the atmosphere of high absolute humidity formed near the transfer passage in the vicinity of the entrance 21a moves upward, so, although the bread f is cooled as it moves upward, it is surrounded by an atmosphere of high relative humidity until it reaches the upper part of the quick cooling chamber 23a. Therefore, the bread f just after baked is cooled quickly in a state evaporation of water from the surface thereof is suppressed, and as shown in FIG. 7, the surface temperature of the bread f falls to 15° C. which is the preset temperature of the slow cooling chamber 23b.

The bread f arriving at the upper part of the quick cooling chamber 23a enters the slow cooling chamber 23b through the opening 21c, moves down on the descending transfer part 22b, and goes out of the slow cooling chamber 23b through the exit 21b.

In the slow cooling chamber 23b, the cold air c blown out from the refrigerating machine 24b flows downward and the hydrated air effused from the humidifier 27b flows downward rising on said cold air flow, so the descending transfer part 22b is surrounded by an atmosphere of high relative humidity.

As the surface temperature of the bread f is lowered to 15° C. until there is no temperature difference between this and the temperature of the slow cooling chamber 23b and the bread f is surrounded by a highly humid atmosphere of relative humidity of 90%, evaporation of water from the surface of the bread f is suppressed, on the contrary, absorption of water from the atmosphere is rather promoted, the water evaporated in the quick cooling chamber 23a is recovered.

In this way, according to the fourth embodiment, as the cooling house 21 is partitioned into the quick cooling chamber of upstream side and the slow cooling chamber 23b of downstream, quick cooling of the bread is performed in the quick cooling chamber 23a under relatively high relative humidity of 60% by virtue of a large temperature difference between the surface temperature of the bread just after baked and that of the atmosphere in the chamber, and in the slow cooling chamber 23b temperature difference between the surface of the bread and the atmosphere in the chamber is reduced to zero and the bread is cooled until the temperature of the center part of the bread becomes 25° C. or lower while recovering water content of the bread under an atmosphere of high relative humidity of 90%, quick cooling of the bread just after baked is made possible, the bread can be cut well without developing a rough cut surface, and good eating quality having moist and glutinous taste can be maintained with reduction in process yield caused by cooling being limited to a minimum.

### The Fifth Embodiment

Next, the fifth embodiment of the invention will be explained with reference to FIG. 9. In FIG. 9, reference numeral 31 is a cooling house divided with a party wall 36 into a quick cooling chamber 33a for cooling quickly the surface of bread after just baked and a slow cooling chamber 33b for cooling the center part of the bread slowly. Reference numeral 32 is a vertical conveyor consisting of horizontal transfer parts 32a and vertical transfer parts 32b, the bread f just after baked placed on the conveyor 32 is introduced into the quick cooling chamber 33a through an entrance 31a of the cooling house 31, transferred by way of the horizontal transfer parts 32a and vertical transfer parts 32b and through an opening of the party wall 36 to the slow cooling chamber 33b, and lastly carried out of the cooling house 31 from an exit 31b thereof.

In the quick cooling chamber 33a, a humidifier 35a is provided near the entrance 31a, and a cold air circulation flow c is generated by a refrigerating machine 34a. In the slow cooling chamber 33b, another humidifier 35b is provided near the opening 36a of the party wall 36, and a cold air circulation flow c is generated by anther refrigerating machine 34b.

Temperature sensors T1 and T2 are provided in the upstream and downstream side respectively of the refrigerating machine 34a. In the quick cooling chamber 33a, a humidity sensor M1 is provided near the position where the bread f begins to be transferred on the conveyor 32, and a temperature sensor T3 and a humidity sensor M2 are provided near the opening 36a of the party wall 36. In the slow cooling chamber 33b are also provided temperature sensors T4˜T6 and humidity sensors M3 and M4 in the upstream and downstream side of the refrigerating machine 34b and an exit 31b likewise as shown in FIG. 9. A control system same as that of the fourth embodiment shown in FIG. 8 is provided, and temperature and humidity in the quick cooling chamber 33a and slow cooling chamber 33b are controlled respectively as shown in FIG. 7 by the controller.

With the configuration, when the bread f just after baked placed on the conveyor 32 is introduced into the quick cooling chamber 33a from the entrance 31a, the air around the bread f just after baked and being hot is heated by heat transfer including thermal radiation from the hot bread f, hydrated air effused from the humidifier 35a is added to the air heated by the bread and the water in the hydrated air is evaporated, and an atmosphere of high absolute humidity is formed around the bread f. As the difference in temperature is large between the bread f just after baked and the cold air blown out from the refrigerating machine 34a, the bread f just after baked is cooled quickly.

The bread f is gradually cooled as it is transferred downstream in the quick cooling chamber 33a, and since it is cooled in a state it is surrounded by an atmosphere in which the air of high absolute humidity formed in the upstream side of the cold air circulation flow exists rising on the circulation flow, evaporation of water from the bread can be suppressed.

When the bread f is transferred through the opening 36a into the slow cooling chamber 33b, as relative humidity of 90% and temperature of 15° C. which is slightly higher than that in the quick cooling chamber 33a are maintained in the slow cooling chamber 33b by the humidifier 35b and refrigerating machine 34b and the surface temperature of the bread is lowered to about 15° C. at the entrance to the slow cooling chamber 33b, the bread f absorbs water from the surface thereof in the highly humid atmosphere in a state there is no temperature difference between the bread f and the atmosphere, so the bread f can recover the water evaporated in the quick cooling chamber 33a.

By this, the bread just after baked can be cooled with evaporation of water being extremely suppressed, so reduction in process yield caused by cooling is limited to a minimum and moist and glutinous eating quality can be maintained. Further, as the bread just after baked can be cooled until the temperature of the center part of the bread becomes 25° C., the bread can be cut well without developing a rough cut surface.

### INDUSTRIAL APPLICABILITY

According to the present invention, when cooling bread just after baked to proceed to next processes of wrapping, refrigeration, etc., cooling can be performed with ease in operation, with cooling period reduced, with process yield increased, and with eating quality maintained through preventing evaporation of water from the bread, by cooling the bread while it is transferred on a conveyor in a cooling chamber controlled in temperature and humidity as compared with conventional batch type apparatuses.

1. A method of cooling bread just after baked in which the bread just after it is baked is introduced into a cooling chamber on a conveyor to be carried out of the cooling chamber after the bread is cooled by allowing to reside therein for a period of time needed for cooling, wherein
inside temperature of said cooling chamber is maintained at 5-20° C., and
the transfer space surrounding the transfer passage of said conveyor is allowed to be a space of highly humid cooling space of relative humidity of 60% or higher by supplying hydrated air to an upstream side part of transfer direction of said conveyor where temperature is highest in the cooling chamber by virtue of the heat of the bread just after baked to form a region of high absolute humidity around the bread transferred in the cooling chamber.

2. The method of cooling bread just after baked according to claim 1, wherein said transfer space surrounding the transfer passage of the conveyor is maintained to be of relative humidity of 90-100%.

3. A method of cooling bread just after baked in which the bread just after it is baked is introduced into a cooling chamber on a conveyor to be carry out of the cooling chamber after the bread is cooled by allowing to reside therein for a period of time needed for cooling, wherein
said cooling chamber is partitioned into a quick cooling region maintained at a low temperature for cooling the surface of the bread quickly and a slow cooling region maintained at a temperature higher than that of said quick cooling region for cooling the center part of the bread slowly,
said bread just after baked is first introduced into said quick cooling region maintained at low temperature,
a region of high absolute humidity is formed in said quick cooling region around the bread by supplying hydrated air to an upstream side part of transfer direction of said conveyor where temperature is highest in said quick cooling region by virtue of the heat of the bread just after baked so that the bread just after baked is cooled quickly while thus allowing the transfer space surrounding the transfer passage of said conveyor to be of an atmosphere of high relative humidity,
then the bread is transferred from said quick cooling region to said slow cooling region,
a region of high absolute humidity is formed in said slow cooling region around the bread by supplying hydrated air to an upstream side part of transfer direction of said conveyor where temperature is highest in said slow cooling region by virtue of the heat of the bread just after transferred into said slow cooling region so that the bread is humidified while thus allowing the transfer space surrounding the transfer passage of said conveyor in said slow cooling region to be of an atmosphere of high relative humidity higher than that of said quick cooling region.

4. The method of cooling bread just after baked according to claim 3, wherein
said transfer space in said quick cooling region is maintained at 5-15° C. in temperature and 60-80% in relative humidity, and
said transfer space in said slow cooling region is maintained at 15-25° C. in temperature and 80-100% in relative humidity.

5. An apparatus for cooling bread just after baked comprising:
a cooling chamber in which cooling space is formed,
a conveyor for carrying bread just after baked placed thereon into and out of said cooling chamber, and
composed such that the bread just after baked is allowed to reside in said cooling chamber for a period of time needed for cooling by adjusting transfer speed of said conveyor, wherein are provided;
a refrigerating machine in said cooling chamber to blow out cooling air stream toward the starting position of transfer of the bread in the cooling chamber, and
a humidifier to effuse hydrated air toward an upstream side part of transfer direction of said conveyor where temperature is highest in the cooling chamber by virtue of the heat of the bread just after baked.

6. The apparatus for cooling bread just after baked according to claim 5, wherein
said conveyor is a spiral conveyor spiraling vertically to form a transfer space to transfer the bread just after baked vertically spirally on said spiral conveyor,
said humidifier is located near the starting position of said transfer space, and
said refrigerating machine is configured so that the cooling air stream blown out from said refrigerating machine is directed from the starting position of said spiraling transfer space toward downstream thereof.

7. The apparatus for cooling bread just after baked according to claim 5, wherein
said conveyor is a vertical conveyor,
said humidifier is located near the part where the horizontal transfer part of the conveyor just after it enters into said cooling chamber continues to the first vertical part of said conveyor, and
said refrigerating machine is configured so that the cooling air stream blown out from said refrigerating machine is directed from the entrance side of the vertical conveyor toward the exit side thereof.

8. The apparatus for cooling bread just after baked according to claim 5, wherein
said cooling chamber is partitioned into a quick cooling region for cooling the surface of the bread quickly and a slow cooling region for cooling the center part of the bread slowly,
said conveyor is arranged such that it first enters into said quick cooling region and then advances out of the quick cooling region to enter into said slow cooling region, and
said refrigerating machine and humidifier are provided in each of said quick cooling region and slow cooling region.

9. The apparatus for cooling bread just after baked according to claim 8, wherein said conveyor is a spiral conveyor or a vertical conveyor.
